(19) United States
(12) Patent Application Publication
(10) Pub. No.: US 2008/0214424 A1
(43) Pub. Date: Sep. 4, 2008

(54) Soluble Unit Dose of Laundry Detergent

(76) Inventors: Stephen George Barnwell, Wirral (GB); Paul Chadwick, Wirral (GB); John George Chambers, Wirral (GB); Peter Graham, Wirral (GB); Philip Ronald Moore, Wirral (GB); David Christopher Thorley, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/631,731

(22) PCT Filed: Jun. 14, 2005
(86) PCT No.: PCT/EP05/06370

§ 371 Date: Aug. 2, 2007

(30) Foreign Application Priority Data
Jul. 6, 2004 (GB) 0415128.8

(51) Int. Cl. C11D 17/04

(52) U.S. Cl. 510/298

(57) ABSTRACT

A soluble unit dose of laundry detergent which comprises: a) a thin walled hard capsule, having a wall thickness between 0.07 and 0.3 mm and, c) within the thin walled hard capsule a detergent composition comprising at least 1 g of surfactant, which makes up at least 45% wt of the detergent composition. wherein the solubility of the capsule and the detergent composition is such that it will reach a level of 90% of eventually dissolved electrolytes in stirred demineralised water at 25° C. in less than 35 seconds. By choice of a capsule with this wall thickness the solubility is ensured while pressure caking of the contents is resisted to minimise overall dissolution time.

The present invention relates to improved products and processes for fabric laundering.

Washing can be a chore. Not only does one have to measure out the correct quantity of detergent, but also it invariably runs out and one has to carry a new box of detergent back from a shop. In typical European wash conditions, the conventional dosage of a laundry product is 7 g/l in about 8 to 15 litres of water depending on the machine and load. The introduction of detergent tablets has, to some extent, avoided the difficulties of measurement, particularly the problem of over-dosage and the subsequent wastage of surfactants etc.

Tablets are just one form of ‘Unit dose’ means of delivery for detergent compositions useful in home laundry and have been known for many years. Early products of this type included sachets, which opened in the wash. These have the disadvantage that the sachet must be recovered at the end of the wash. More recently, tablets and water-soluble sachets have provided means for delivering detergents without the need for recovery of some component.

Some forms of laundry tablet use various disintegrant materials, which either swell on contact with water or dissolve rapidly. It is also known to form tablets from a loosely sintered material and then coat the tablet with a dicarboxylic acid based material to provide some structural integrity. For tablets which are delivered via the drum (as opposed to drawer dispensed) it is known to use a net-like bag to prevent the tablet staying in one place and producing a prolonged contact between the tablet and the fabrics being washed.

Where disintegrant materials are present, these add to the weight of the tablet. A consequence of this is that tablets do little to reduce the box weight at the point of sale for the equivalent number of washes, as compared with powders. With both tablets and conventional powders, less than a third of the weight in the box is actually detergent. Conventional laundry powders achieve a maximum of 30% wt detergent active and require a solid carrier (usually builder) for the surfactant.

WO 01/36290 A1 discloses an injection moulded rigid, water soluble container, which may be made of hydroxypropylmethyl cellulose, and contains a fabric care, surface care or dishwashing composition. Various advantages are stated for the injection moulding process. A problem with such a container is that using normal injection moulding technology the wall thickness of the container, or capsule, will be too thick to allow it to dissolve fast enough for use in a machine laundry process. The thickness of the injection-moulded self supporting, rigid, receptacle is stated to be preferably in the range 500 to 1000 microns. The person skilled in the art is aware that large injection moulded components cannot be made efficiently with a thickness below about 0.3 mm. The examples in WO 01/36290 A1 used a wall thickness of 0.8 mm and typically released their contents in about 30 to 40 minutes.

DE 199 31 399 A1 and its equivalent CA 2313587 also disclose a capsule filled with detergent. The capsule is made with a small aperture to allow the wash medium to enter and assist in disrupting the capsule by reacting with the contents of the capsule. The material from which the capsule is formed is not supposed to be soluble in water. A problem with the capsule having such an aperture is that it allows moisture vapour to enter the capsule and therefore has a negative effect on the storage stability of the filled capsule.

It would be advantageous to reduce the weight/dosage per wash of laundry products while retaining the convenience of unit dose form. One approach to this would be to remove disintegrant materials and builders from the formulations. This has proved difficult as detergents are often sticky materials and in high active formats can ‘pressure-cake’ forming a slow dissolving mass. They also have a tendency to adsorb water and react with other ingredients.

We have determined that it is of advantage to use a calcium-tolerant surfactant and provide this in an essentially unbuilt unit dose form within a relatively rigid and moisture resistant shell. The advantages of such a formulation are that it takes up less physical space and that it contributes less chemical loading to the environment. Use of a calcium tolerant surfactant in the detergent composition enables some or all of the builder to be removed from the composition which in theory enables the composition to have levels of surfactant of at least 45 wt % without compromising wash performance significantly. Before use of the hard capsule, the problem has been to prevent such compositions from pressure caking. Use of a hard capsule of the type described in WO 01/36290 A1 would lead to dissolution times that are unsuitably long for laundry processes. This being due to their thick walls.

Accordingly, the present invention provides a soluble unit dose of laundry detergent which comprises: a thin hard capsule and, within said capsule a detergent composition comprising at least 45% wt of a surfactant, the capsule dissolving in demineralised water at 20 to 25° C. sufficiently to give T90 values for the total soluble unit dose comprising capsule and detergent composition of less than 350 s, preferably less than 300 s and most preferably less than 180 s, or substantially the same T90 value as would be obtained for the detergent composition alone.

The capsule should be thin enough to dissolve at the required rate and thick enough to prevent undue compaction of the contents and the consequent possibility of pressure caking.

The contents of the capsule are preferably in powder form. Use of a fine powder avoids the problem of gelling of the contents in the capsule to achieve lower T90 values.

The capsule is advantageously manufactured by coating on a pin. This is a cost-effective way to produce a capsule of the required thin wall thickness. The preferred method is dip coating. Alternatively, an electrostatic pin coating method may be used. State of the art injection moulding may be used provided capsule material with a high enough melt flow index to obtain the required thin wall is employed. Use of conventional injection moulding equipment would lead to thicker walls or very slow and uneconomic production times. Pin dip coating is also more economic and suitable for this purpose than injection moulding because pin dip coating is done by using a solution of the capsule material, which guarantees the capsule's subsequent solubility.

The shape of the capsule is selected to give the minimum total weight for the capsule and its contents. Thus, a shape that enables more than 80% by volume fill of the capsule is preferred (i.e. less than 20% ullage); fills of 90% are even more preferred. The classical pharmaceutical two part capsule shape fulfils this function, especially if it is scaled up for the larger sizes that may be needed. When large capsules are used, the wall thickness is not scaled up to the same extent as the overall dimensions.

Advantages of hard capsules over a flexible pouches or soft capsules include:
(a) the dissolution rate and free flowing appearance of the powder contents is not compromised by being compacted during storage (pressure caking).
(b) the powder contents can be filled to a higher percentage of the maximum volume.

Furthermore, capsules are more robust than coated tablets that tend to be more friable once the coating is cracked or otherwise damaged. In any case the compaction needed to form a tablet is, in effect, the pressure caking that the present invention seeks to avoid.

A further aspect of the present invention relates to a method for laundering garments which comprises the step of introducing into a washing machine at least two thin hard capsules which each contain a detergent composition.

Preferably, each capsule contains at least one gram of surfactant. More preferably, each unit dose provides at least 5 g of surfactant, even more preferably 7 g surfactant.

In this specification, the term unit-dose means enough detergent composition for a half wash load and preferably that 2 to 5, more preferably 2 to 3 capsule loads of detergent formulation provide the quantity of laundry detergent required for a wash load.

The System

The solubility of the capsule and its contents is preferably such that the filled capsule will dissolve and deliver the contents to reach a level of 90% of eventually dissolved electrolytes in stirred demineralised water at 25° C. in less than 350 seconds, preferably less than 250 s most preferably less than 180 s. This lower time is similar to the time that the detergent composition would dissolve on its own and requires fast disruption of the capsule wall. This is assisted by use of the thin walled capsules according to the invention.

It may be thought to be advantageous for aesthetic reasons that the capsules are at least semi-transparent so that the particles are visible through the walls of the capsule. However, we have determined that for the detergent compositions preferred, namely those that are high active compositions that have a tendency to cake or to have a paste-like form, the capsule should be opaque. This hides the potentially unpleasant appearance of the contents and eliminates the need to use unnecessary colorants and other chemicals in the detergent composition. Furthermore, it means that formulation or raw material changes that have an impact on powder appearance or flow properties can be made without concern for their impact on product appearance. It also allows the capsule to be easily and clearly overprinted to identify it. This feature of printing is particularly important to ensure that capsules are not accidentally confused with pharmaceutical products and the like. The capsule may also be coloured.

The Capsule

The hardness of the capsule is such that when empty it is self-supporting under gravity. In the pharmaceutical art, such capsules are known simply as ‘hard capsules’. Details of the parameters and manufacture of such capsules can be found in ‘Hard Capsules-Development and Technology’ edited by K Ridgway, Pub. The Pharmaceutical Press, London, 1987. Further information can be found in ‘Pharmaceutical Capsules’ Second edition (First edition was entitled ‘Hard Capsules’) edited by Brian Jones & Fridrun Podczeck. (Balogh International, 2004). By the use of so-called ‘hard capsules’, it is possible to encapsulate high active detergent compositions in a solid yet usable form. The rigidity of the capsule reduces and advantageously substantially prevents ‘pressure-caking’ of the detergent composition, especially if it is provided in powder form and has a relatively high level of surfactant.

Preferred materials for the manufacture of such capsules are cellulose ethers such as hydroxy-propylmethylcellulose (HPMC) or other polymers of similar or better solubility. Gelatine has been found to have an unsatisfactory dissolution profile, as it is insufficiently soluble at temperatures below 40° C. Lower wash temperatures are already commonplace in many markets and are increasingly preferred in others due to the reduced impact on energy consumption and its contribution to climate change. Suitable capsules may be made from starch, or other suitable material including HPMC such as Quali-V® manufactured by Shionogi Qualicaps or Vcaps™ made by Capsugel. Capsules that combine gelatine with other materials, for example the PEG gelatine capsules made available by Shionogi may have the required faster dissolution times.

HPMC is preferred due to its favourable dissolution characteristics, which are largely temperature independent, and low residues, being mainly a function of the thickness of the wall and the type of HPMC used.

Two-piece hard capsules are particularly preferred: these are widely available, in smaller sizes, from suppliers to the pharmaceutical industry. These known hard capsules are an effective moisture resistant barrier for the purposes of the present invention. They are known in the pharmaceutical art as ‘two-piece hard capsules’. As is known in the capsule art the two piece capsule may be sealed by use of an appropriate banding method after filling and closure to the “locked” position. Alternatively or additionally, the capsules may be coated with materials that further reduce moisture ingress and/or modify dissolution and release characteristics.

Desirably the volume of capsule is 10 to 30 ml and the thickness of the capsule wall between 50 to 150 microns. Capsule dissolution is a function of wall thickness, and capsules with thicker walls dissolve more slowly.

Tests have been carried out with capsules within the range of sizes shown in Table 1 below. Larger capsules sizes are produced for veterinary applications.

TABLE 1
Capsule Dimensions

| Standard | | | |
|---|---|---|---|
| Pharmaceutical | | | |
| Capsule Size | | | Wall thickness |
| (number) | Diameter (mm) | Volume (ml) | (mm) |
| Su07 | 23.4 | 28 | 0.18-0.24 |
| 7 | 23.4 | 24 | 0.22-0.40 |
| 10 | 23.4 | 28 | 0.36-0.47 |
| 11 | 20.9 | 10 | 0.16-0.24 |
| 12el | 15.5 | 7.5 | 0.29-0.36 |
| 12 | 15.3 | 5.5 | 0.15-0.24 |
| 13 | 15.3 | 3.2 | 0.16-0.25 |
| 000 | 9.97 | 1.37 | 0.11 |
| 00 | 8.53 | 0.95 | 0.11 |
| 0 | 7.65 | 0.68 | 0.10 |
| 1 | 6.91 | 0.50 | 0.10 |
| 2 | 6.35 | 0.37 | 0.10 |
| 3 | 5.82 | 0.3 | 0.09 |
| 4 | 5.31 | 0.21 | 0.09 |
| 5 | 4.91 | 0.13 | 0.09 |

As the capsule volume increases the level of capsule material per dose of detergent composition is reduced. However, an important part of this invention lies in the realisation that greater weight effectiveness is also achieved by reducing the capsule wall thickness near to the minimum that solves the pressure caking problem. The evidence to the solution to this problem being the low T90 values for the combination of capsule and its detergent composition contents.

For instance, a size 11 capsule as shown in Table 1 with a volume of 10 ml could contain approximately 7 g of LAS granules. Then the approximate fractional weight of the capsule shell is shown as a function of wall thickness in Table 2 below. Clearly showing that shell wall thickness is a critical parameter in weight-effectiveness. If high active granules are used the weight saving in the formulation is up to 30%. Thus the capsule weight should be less than the weight saving from eliminating builder and other chemicals from the composition, which means using a capsule wall thickness of less than 0.3 mm for the capsule sizes in table 2.

TABLE 2

| | Weight of Empty Capsule/ |
|---|---|
| Wall Thickness | Weight of Filled |
| (mm) | Capsule (%) |
| 0.08 | 11% |
| 0.15 | 16% |
| 0.30 | 27% |
| 0.50 | 38% |
| 0.75 | 48% |
| 1.00 | 55% |

The Detergent Composition

The contents of the capsule are preferably of particulate form. As will be described in further detail below, particulate ‘HAG’s (high active granules) can be made by a variety of methods. The particle size of these granules can vary from a powder-like form (typically 0.1 to 0.2 mm diameter) to a more bead-like form (typically above 10 mm diameter). Preferably, the capsules of the present invention contain particles with an average diameter of 0.1-0.2 mm in any given plane: i.e. these can be spherical or shaped in the form of tablets, buttons, counters, spheroids, needles, flakes or pills. Pastes, gels, liquids, tablets and other product forms may also be employed, although substantially spherical particles are preferred and powders are most preferred.

Preferably, the surfactant is a calcium tolerant surfactant (which term is intended to include a calcium tolerant blend of surfactants comprising in part at least one calcium intolerant surfactant).

Calcium tolerant surfactants are those which do not require builders to be present for their effectiveness. The test method for ‘calcium-tolerance’ is as follows:—the surfactant blend in question is prepared at a concentration of 0.7 g/l in water containing sufficient calcium ions to give a French hardness of 40 (4×10 Molar Ca²⁺). Other electrolytes such as sodium chloride, sodium sulphate, sodium hydroxide are added as necessary to adjust the ionic strength to 0.05 M and the pH to 10. The adsorption of light of wavelength 540 nm through 4 mm of sample is measured 15 minutes after sample preparation. Ten measurements are made and an average value is calculated. Samples which give a value of less than 0.08 are deemed to be calcium tolerant.

A known problem with high active granules (HAGs) is the tendency for the very high surfactant levels to cause the granules to stick together, especially under pressure. This phenomenon is often referred to as pressure caking. Various tests are used to predict the degree to which a powder is liable to pressure caking. We believe that the so-called “unconfined compression test” or UCT is a good indicator of the extent of the problem for the present invention. The test is described below:

Unconfined Compression Test (UCT)

In this test freshly produced powder is compressed into a compact and the force required to break the compact is measured. The powder is loaded into a cylinder and the surface levelled. A 50 g plastic disc is placed on top of the powder and a 10 kg weighted plunger is placed slowly on top of the disc and allowed to remain in position for 2 minutes. The weight and plunger are then removed and the cylinder removed carefully from the powder to leave a free-standing cylinder of powder with the 50 g plastic disc on top of it. If the compact is unbroken, a second 50 g plastic disc is placed on top of the first and left for approximately ten seconds. Then if the compact is still unbroken a 100 g disc is added to the plastic discs and left for ten seconds. The weight is then increased in 250 g increments at 10 second intervals until the compact collapses. The total weight (w) needed to effect collapse is noted.

The cohesiveness of a powder is classified by the weight (w) as follows:

w<1000 g Good flowing

1000 g<w<2000 g Moderate flowing.

2000 g<w<5000 g Cohesive.

5000 g<w Very cohesive.

### COMPARATIVE EXAMPLES A and B

To show the significance of the type of detergent composition on the problem of pressure caking if the capsule is insufficiently rigid, we performed the following test: For comparative example A sachets made from flexible water soluble polymer film were filled with a formulation containing 50% high active granules of sodium LAS, (granules contain 65% surfactant) and 50% of electrolyte. Thus, this composition has a lower surfactant content than the 45% required in the present invention. These capsules were packed in sealed glass bottles. The latter each contained one capsule, packed under a 100 g weight. After storage for 1 week at 37° C. the capsules were removed and assessed for pressure caking by removing the powder from the soft capsule and examining powder flow. All of the capsules were found to have formed solid lumps with no significant amount of free flowing powder. Further storage for 1 week produced sachets with single large soft lumps.

For Comparative Example B, the same type of sachets contained conventional spray dried STPP base powder, (% AD=16.5%) and the storage test was repeated. The powder was found to be stable with respect to pressure caking, even after 75 days storage.

UCT Values

Typically the Unconfined Compression test, (UCT) is used as a guide to pressure caking and powder flow. For pressure caking during storage, (i.e. post-packaging but prior to use) the ambient temperature experienced by the product is not controlled and may be as high as 35° C. Hence the relevant UCT for predicting pressure caking is the value measured at 35° C. Examples of UCT values at 35° C. are given in Table 3.

TABLE 3

| | | % surfactant |
|---|---|---|
| | UCT value | in |
| Detergent composition | at 35° C./g | composition |
| Spray dried STPP base powder | 500 | 20% |
| containing 20% sodium LAS | | |
| High Active granules | 1200 | 65% |
| containing 65% sodium LAS | | |
| High Active granules | 4250 | 100% |
| containing 100% surfactant, | | |
| (LAS/PAS = 90/10) | | |
| High Active granule containing | >5000 | 80% |
| 80% LAS/PAS = 1/1 + 20% PEG6000 | | |

The data in this Table illustrate the higher UCT values associated with powders containing high (>45% or even >65%) surfactant content. Consequently, such powders cannot be used in conventional boxes or in non-rigid sachets due to their pressure caking tendency. Surprisingly we have found that by using a thin walled capsule we can store and use such powders and the problem of their liability to pressure cake is sufficiently overcome. This problem is particularly associated with detergent compositions having low levels of builder and/or filler and high levels of surfactant.

Surfactants

Many suitable detergent active compounds are available and are fully described in the literature, for example, in “Surface-Active Agents and Detergents”, Volumes I and II, by Schwartz, Perry and Berch.

Preferred surfactants are alkyl ether sulphates and blends of alkoxylated alkyl nonionic surfactants with either alkyl sulphonates or with alkyl ether sulphates.

Preferred alkyl ether sulphates are C₈-C₁₈ alkyl and have 2 to 10 moles of ethoxylation. Particularly preferred materials are salts of lauryl ether sulphate with an average of three ethoxylate units per molecule.

Preferred alkyl sulphonates are alkylbenzene sulphonates, particularly linear alkylbenzene sulphonates having an alkyl chain length of C₈-C₁₅.

The counter ion is typically sodium, although other counter-ions such as potassium, magnesium, calcium, TEA or ammonium can be used. Suitable anionic surfactant materials are available in the marketplace as the ‘Genapol’™ range from Clariant.

Nonionic surfactants that may be used include the primary and secondary alcohol ethoxylates, especially the C₈-C₂₀ aliphatic alcohols ethoxylated with an average of from 1 to 50 moles of ethylene oxide per mole of alcohol, and more especially the C₁₀-C₁₅ primary and secondary aliphatic alcohols ethoxylated with an average of from 10 to 40 moles of ethylene oxide per mole of alcohol.

Examples of suitable surfactants and blends are given in the Table 4 below. As noted above, some of the surfactants found in these calcium tolerant combinations, may be calcium intolerant in isolation. This is believed in part to be due to the formation of mixed micelles. For example, LAS, PAS, SAS, soaps and FAES may not be not calcium tolerant when taken in isolation, but can form an overall calcium tolerant mixture when mixed with appropriate levels of other surfactant species.

TABLE 4

| Surfactant | Ratio |
|---|---|
| LAS/Nonionic7EO | 60/40 |
| LAS/Nonionic30EO | 90/10 |
| LAS/Nonionic30EO | 60/40 |
| LAS/SLES 3 EO | 90/10 |
| APG | 100 |
| SLES 3 EO | 100 |
| Nonionic 7EO | 100 |

LAS = sodium salt of linear alkyl benzene sulphonate with an alkyl chain distribution of C9-14 and less than 25% of 2-phenyl isomer.
Nonionic 7EO = C11-14 linear alkyl chain with an average of 7 ethoxylate units per molecule.
Nonionic 30EO = C13-15 linear alkyl chain with an average of 30 ethoxylate units per molecule.
APG: Alkyl polyglucoside, with an alkyl chain length of C9-C10 and an average of 1.7 glucose units per molecule.

Particularly preferred combinations of surfactants are: LAS/NI-30EO at ratios less than or equal to 90/10 LAS/NI 7EO at ratios less than or equal to 60/40 LAS/SLES (3EO) at ratios less than or equal to 90/10

As noted above the level of surfactant in the detergent composition within the capsule is at least 45% by weight. Levels of surfactant are generally above 50% wt and can be as high as 90% wt or even 95% wt. Preferred levels of surfactant are 50 to 80% wt.

Builders

Where builder is present, the detergent compositions within the capsule may suitably contain less than 20% wt, preferably less than 10% by weight.

The detergent composition may contain as builder a crystalline aluminosilicate, preferably an alkali metal aluminosilicate, more preferably a sodium aluminosilicate. This is typically present at a level of less than 20% w. Aluminosilicates are materials having the general formula:

0.8-1.5 M₂O. Al₂O₃. 0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to aluminosilicate (where present) is preferably greater than 2:1 more preferably greater than 3:1.

Alternatively, or additionally to the aluminosilicate builders, phosphate builders may be used. Typical levels of phosphate in the compositions of the present invention are less than 5% wt of the detergent composition contained within the capsule. The ratio of surfactants to phosphate is preferably greater than 5:1, more preferably greater than 10:1.

Preparation of High Active Granules

The preferred way of making high active granules is to use a so-called VRV™ flash drier using, for example, the method disclosed in WO9606917. Alternatively, high active granules can be produced using a wiped film evaporator, (e.g. the ‘Dryex™’ active matter drying unit of Ballestra S.p.a., Milan, Italy as detailed in Ballestra Supplier Literature May 1998). So called ‘chilled drum’ and spray drying methods can be used. The preparation of such high active granules is known in the detergent industry, but they are only incorporated in products at low levels, due to their stickiness and caking properties.

Other Components

Compositions according to the invention may comprise soil release polymers such as block copolymers of polyethylene oxide and terephthalate.

Other optional ingredients include electrolytes, (for example sodium chloride) buffering agents, (for example sodium silicate, sodium carbonate) preferably each in the range from 0.01 to 20% by weight and perfumes (preferably from 0.1 to 5% by weight).

Further optional ingredients include non-aqueous solvents, emulsifiers, perfume carriers, fluorescers, colorants, hydrotropes, antifoaming agents, enzymes, optical brightening agents, and opacifiers.

Suitable bleaches include peroxygen bleaches. Inorganic peroxygen bleaching agents, such as perborates and percarbonates are preferably combined with bleach activators. Where inorganic peroxygen bleaching agents are present, the nonanoyloxybenzene sulphonate (NOBS) and tetra-acetyl ethylene diamine (TAED) activators are typical and preferred. Catalytic bleach systems can be employed.

Suitable enzymes include proteases, amylases, lipases, cellulases, peroxidases and mixtures thereof.

In addition, compositions may comprise one or more of anti-ashing agents, anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. The lists of optional components are not intended to be exhaustive.

In specific embodiments of the invention, incompatible materials (such as certain bleaches and certain perfumes) are present in separate granules/capsules/compartments within the hard capsule. Minor amounts of functional ingredients may be present in the capsule wall material.

In order that the invention may be further and better understood it will be described below with reference to the following non-limiting examples.

### EXAMPLES

### Examples 1-7

### Surfactant Composition

Table 5 below provides formulations used in embodiments of the present invention.

TABLE 5

| | 1 | 2 | 3 | 4 | 5 | 6 | 7 |
|---|---|---|---|---|---|---|---|
| LAS Granules | 70 | 70 | 70 | 60 | 60 | 50 | 0 |
| NI 30EO | 30 | 20 | 10 | 20 | 0 | 0 | 20 |
| SLES-3EO | 0 | 0 | 0 | 0 | 30 | 30 | 60 |
| Na carbonate | 0 | 0 | 0 | 0 | 10 | 20 | 20 |
| K carbonate | 0 | 10 | 20 | 20 | 0 | 0 | 0 |

The LAS granules were made by the process described in WO9606917 and contained 65% of LAS. The Nonionic 30EO was Lutensol™ AO30. The SLES-3EO was Steol® BES 70, a dried 70% SLES paste ex Stepan.

### Example 8

### Capsule Dissolution Tests

LAS granules of composition shown above in Examples 1-7 and made by the process described in WO9606917 were hand-filled into hard capsules made from hydroxypropyl methylcellulose of different sizes. These were tested for solubility using the T90 method as follows.

A 1-litre beaker was filled with 500 mls of demineralised water at 20-25° C. and stirred with a magnetic stirrer adjusted to give a vortex of about 4 cm. A single HPMC capsule was used in each test. The capsules freely float and the vortex helps to ensure they are fully in contact with the water. In a laundry process, the capsules would be submerged in water by the action of the wash and the presence of garments.

The dissolution of these systems is monitored by measuring solution conductivity. The ‘T90’ value is the time taken to achieve 90% of the final conductivity value. In each case, the wall thickness of a range of capsules of that size was measured using Vernier callipers. The average T90 results are shown in Table 6.

TABLE 6

| | | | Capsule | |
|---|---|---|---|---|
| | LAS granule | Capsule wt. | thickness | |
| Size | wt (g) | (g) | (mm) | T90 (s) |
| 0 | 0.5 | 0.095 | 0.08-0.14 | 344 |
| 13 | 2 | 0.53 | 0.16-0.25 | 500 |
| 12 | 3 | 0.72 | 0.15-0.24 | 500 |
| 12el | 4.6 | 1.02 | 0.29-0.36 | 700 |
| 11 | 6.5 | 1.30 | 0.16-0.24 | 960 |
| 10 | 12 | 2.00 | 0.36-0.47 | 800 |
| 07 | 17 | 2.30 | 0.18-0.24 | 1000 |

Because the capsule will dissolve faster where the wall is thinner, the minimum wall thickness should normally be considered to be the wall thickness for the purpose of this specification.

### Example 9

### Preparation of Capsules

Compositions according to examples 1-7 were hand-filled into hard capsules made from hydroxypropyl methylcellulose or gelatine. These were tested for solubility.

The capsules were commercial capsules, i.e.
Fast dissolving HPMC (Hydroxy Propyl Methyl Cellulose) code: Quali V—op white, cellulose capsules Size 0 sourced from Shionogi.
Slow dissolving gelatin capsules—size 00, size 000 (70 sf) and size 5 (43 cs)—Blue 504 sourced from Capsugel™.

The dissolution behaviour of the resulting products was measured using the T90 methods hereinbefore described.

A single HPMC capsule was used in each test containing 0.5 g of each of blends 1-7. For the gelatine capsules several capsules were required to hold the target 0.5 g, i.e.
Size 00—0.5 g was added into two capsules
Size 000—0.5 g was added into one capsule
Size 5—0.5 g was added into five capsules.

T90 results for compositions 1-7 in HPMC and gelatin capsules are shown in Table 7. The numbers 1-7 refer to the compositions described in table 5. Only the HPMC unit dose capsules are embodiments according to the invention because with the HPMC capsule, dissolution in less than 350 seconds is achieved, whereas with the comparative gelatine capsules the dissolution times were too long.

TABLE 7

| | 1 | 2 | 3 | 4 | 5 | 6 | 7 |
|---|---|---|---|---|---|---|---|
| HPMC | 278.1 | 306.7 | 307.9 | 344.7 | 264.7 | 269.5 | 313.2 |
| Gelatine 00 | — | — | — | >500 | — | — | — |
| Gelatine 000 | — | — | — | >500 | — | — | — |
| Gelatine 5 | — | — | — | >500 | — | — | — |

### Examples 10-20

### Calcium Tolerance of Surfactants

Examples 10-20 are presented in Table 8. The surfactant blend as specified in the Table was prepared at a concentration of 0.7 g/l in water containing sufficient calcium ions to give a French Hard of 40. Other electrolytes such as sodium chloride, sodium sulphate, sodium hydroxide are added as necessary to adjust the ionic strength to 0.5 M and the pH to 10. The adsorption of light of wavelength 540 nm through 4 mm of sample is measured 15 minutes after sample preparation. Ten measurements are made and an average value is calculated. Samples which give a value of less than 0.08 are deemed to be calcium tolerant.

TABLE 8

| | | Surfactant | Adsorbance | |
|---|---|---|---|---|
| Ex | Sample | Ratio | 540 nm | Pass/Fail |
| 10 | LAS | 100 | 0.267 | Fail |
| 11 | LAS/Nonionic7EO | 90/10 | 0.218 | Fail |
| 12 | LAS/Nonionic7EO | 60/40 | 0.044 | Pass |
| 13 | LAS/Nonionic30EO | 90/10 | 0.061 | Pass |
| 14 | LAS/Nonionic30EO | 60/40 | 0.038 | Pass |
| 15 | LAS/APG | 80/20 | 0.474 | Fail |
| 16 | LAS/SLES 1 EO | 90/10 | 0.140 | Fail |
| 17 | LAS/SLES 3 EO | 90/10 | 0.072 | Pass |
| 18 | APG | 100 | 0.056 | Pass |
| 19 | SLES 3 EO | 100 | 0.048 | Pass |
| 20 | Nonionic 7EO | 100 | 0.045 | Pass |

LAS = sodium salt of linear alkyl benzene sulphonate with an alkyl chain distribution of C9-14 and less than 25% of 2-phenyl isomer.
Nonionic 7EO = C11-14 linear alkyl chain with an average of 7 ethoxylate units per molecule. Available in the marketplace as Neodol ™ 25-7 supplied by Shell, (Surfachem ™)
Nonionic 30EO = C13-15 linear alkyl chain with an average of 30 ethoxylate units per molecule. Available in the marketplace as Lutensol ™ A030 supplied by BASF.
APG = Alkyl polyglucoside, with an alkyl chain length of C9-C10 and an average of 1.7 glucose units per molecule. Available in the marketplace as Glucopon ™ 224DK ex Cognis.

From these results it can be seen that while LAS is a calcium intolerant surfactant in isolation, it can become calcium tolerant in admixture with other surfactants.

### Example 21

### Ingredient Stabilisation

To investigate the possible stabilisation of ingredients by packing them separately within capsules we used sodium percarbonate. We found that the capsule protects the bleach within from decomposing due to contact with a base powder, in a humid atmosphere.

In particular for sodium percarbonate bleach samples stored for 6 weeks at 75% RH and ambient temperature we determined that whilst only 7% of the bleach remained if it was in direct contact with the base powder, having the bleach contained in a small capsule and therefore separated from the base powder by its capsule wall reduced the loss of bleach activity to the extent that 85% of the bleach survived.

### Example 22

### Prevention of Pressure Caking

With reference to Comparative Examples A and B above, identical LAS granules stored alone in size 07 HPMC hard capsules at 28° C. and 37° C. and 70% RH become only loosely caked, and readily flowed out of the capsule.

1. A soluble unit dose of laundry detergent which comprises:
a) a thin walled hard capsule, having a wall thickness between 0.07 and 0.3 mm and,
b) within the thin walled hard capsule a detergent composition comprising at least 1 g of surfactant, which makes up at least 45% wt of the detergent composition.
wherein the solubility of the capsule and the detergent composition is such that it will reach a level of 90% of eventually dissolved electrolytes in stirred demineralised water at 25° C. in less than 350 seconds.

2. A soluble unit dose according to claim 1 wherein the hard capsule wall thickness is between 0.08 and 0.2 mm.

3. A soluble unit dose according to claim 1 or claim 2 which floats when added to water.

4. A soluble unit dose according to any preceding claim wherein the detergent composition has an unconfined compression test value, as defined herein, of greater than 1000 g at 35° C.

5. A soluble unit dose according to any preceding claim wherein the capsule is formed from hydroxy-propylmethylcellulose.

6. A soluble unit dose according to any preceding claim wherein the contents of the capsule are of particulate form.

7. A soluble unit dose according to claim 6 wherein the particles have an average diameter of 0.1 to 2 mm.

8. A soluble unit dose according to any one of the preceding claims wherein the surfactant is a calcium tolerant surfactant as defined herein.

9. A soluble unit dose in which the headspace in the capsule is less than 20%, preferably less than 10%.

10. A soluble unit dose in which the bulk density of the detergent composition is greater than 500, preferably greater than 700 even greater than 900 g/l.

11. A soluble unit dose in which the weight of the capsule makes up less than 20% of the total weight of the unit dose, preferably less than 15%.

12. A soluble unit dose according to any preceding claim wherein the capsule is opaque.

13. A soluble unit dose according to any preceding claim wherein the capsule is coloured.

14. A soluble unit dose according to claim 12 or claim 13 wherein the outside surface of the capsule is printed.

15. A soluble unit dose according to any preceding claim wherein the capsule provides a moisture resistant barrier.

16. A soluble unit dose according to claim 13 wherein the capsule is sealed with a band and provides an effective barrier to the transmission of water vapour.

17. A soluble unit dose according to any preceding claim wherein a part of the detergent composition is contained in a smaller capsule within the main capsule, the smaller capsule preferably being sealed with a band.

18. A soluble unit dose according to claim 17 wherein the smaller capsule contains bleach.

19. A soluble unit dose according to claim 18 wherein the smaller capsule is coated.

20. A method for laundering garments which comprises the step of introducing into a washing machine at least two thin walled hard capsules which each contain a detergent composition comprising more than 45 wt % surfactant, the weight of surfactant in each capsule being at least 1 g.

21. The method according to claim 18 in which the filled capsules initially float on water and are introduced to the washing machine via a dispensing drawer from which they are flushed by a flow of water.

22. A method according to claim 18 or 19 wherein the T90 value for the capsules and their contents is less than 350 s.

23. A method according to claim 20 wherein the T90 value is less than 250 s.

24. A method according to claim 20 wherein the T90 value is less than 180 s.
